(19) United States
(12) Patent Application Publication
(10) Pub. No.: US 2007/0128003 A1
(43) Pub. Date: Jun. 7, 2007

(54) Combination of a nut and a washer

(75) Inventor: Jin Shiu, Yancheng Township (CN)

Correspondence Address: PATENTTM.US, P. O. BOX 82788, PORTLAND, OR, 97282-0788, US

(73) Assignee: SONG HONG INTERNATIONAL CO., LTD.

(21) Appl. No.: 11/292,699

(22) Filed: Dec. 2, 2005

(51) Int. Cl. F16B 43/00

(52) U.S. Cl. 411/533; 411/372

(57) ABSTRACT

A nut includes a body with a first through hole and a disk formed on a bottom face of the body and having multiple first securing elements formed on a bottom face of the disk. A washer includes an annular disk having a second through hole, multiple second securing elements to securely engage with the first securing elements, multiple abutting elements formed on a bottom face of the annular disk for securing engagement with a workpiece surface. Therefore, when the nut and the washer are combined, engagement between the first securing elements and the second securing elements facilitates the tightening process to a workpiece. Each of the first securing elements and of the second securing elements has an inclination direction opposite toward a direction of the abutting elements.

### BACKGROUND OF THE INVENTION

1. Field of the Invention

The present invention relates to a combination of a nut and a washer, and more particularly to a combination of a nut and a washer to readily tighten a workpiece.

2. Description of the Prior Art

With reference to FIG. 10, a conventional bolt (6) has a head (61) and a rod (60) with a threading (62) formed on an outer periphery of the rod (60). A leaf spring (70) and a washer (71) are provided to abut a side face of the head (61) after the rod (60) extends through the leaf spring (70) and the washer (71). After the conventional combination of the bolt (6), the leaf spring (70) and the washer (71) are applied to secure a workpiece (not shown), vibration caused by the application of the workpiece may cause the bolt (6) to rotate, which loosens the tightness to the workpiece provided by the bolt (6). Also, unauthorized personnel may easily unscrew the nut or bolt, if any, to steal the workpiece.

To overcome the shortcomings, the present invention tends to provide an improved combination of a nut and a washer to mitigate the aforementioned problems.

### SUMMARY OF THE INVENTION

The primary objective of the present invention is to provide an improved combination of a nut and a washer to readily tighten a workpiece.

In order to accomplish the foregoing objective, the nut has a body with a through hole defined through the body, a disk formed on a bottom face of the body and multiple first securing elements continuously formed on a bottom face of the disk. The washer has an annular disk having a size corresponding to that of the disk, multiple second securing elements continuously formed on a top face of the annular disk to correspond to the first securing elements of the nut body, a wall formed on an outer periphery of the annular disk and multiple abutting elements formed on a bottom face of the annular disk. Therefore, when the nut and the washer are combined and after the first securing elements are securely connected together, the wall of the washer is bent to enclose the disk so as to secure engagement between the first securing elements and the second securing elements. Then when the combination of nut and washer is employed to secure position of a workpiece, the abutting elements formed on the bottom face of the annular disk of the washer enable that the washer is able to firmly engage with a face of the workpiece.

In one objective of the present invention, each of the first securing elements and of the second securing elements are inclined surfaces.

A further objective of the present invention is that the abutting elements are selected from a group consisting essentially of triangular cutouts, triangular protrusions and wedged teeth.

Other objects, advantages and novel features of the invention will become more apparent from the following detailed description when taken in conjunction with the accompanying drawings.

### BRIEF DESCRIPTION OF THE DRAWINGS

FIG. 1 is an exploded perspective view of the combination of the nut and the washer of the present invention;

FIG. 2 is an exploded perspective view showing the combination of the nut and the washer from a different angle;

FIG. 3 is a schematic side plan view showing the engagement between the nut and the washer;

FIG. 4 is an exploded perspective view of a second embodiment of the combination of the nut and the washer;

FIG. 5 is an exploded perspective view of a third embodiment of the combination of the nut and the washer;

FIG. 6 is an exploded perspective view of a fourth embodiment of the combination of the nut and the washer,

FIG. 7 is an exploded perspective view of the fourth embodiment of the combination of the nut and the washer from a different angle;

FIG. 8 is an exploded perspective view of a fifth embodiment of the combination of the nut and the washer of the present invention;

FIG. 9 is an exploded perspective view of a sixth embodiment of the combination of the nut and the washer of the present invention; and

FIG. 10 is a side plan view of a conventional combination of a bolt, a nut and a washer.

### DETAILED DESCRIPTION OF THE PREFERRED EMBODIMENT

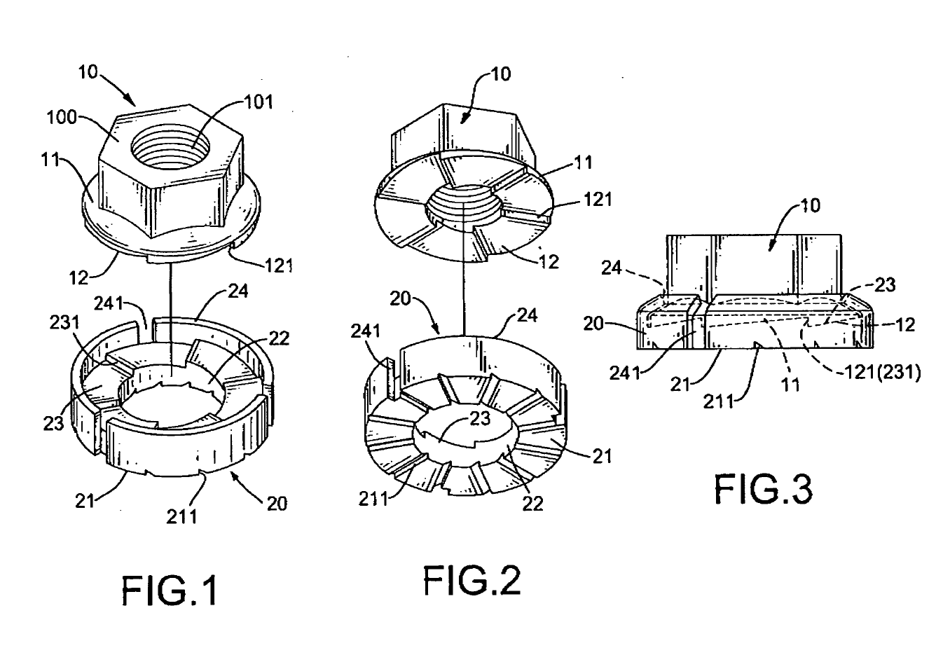

With reference to FIG. 1, it is noted that a nut (10) in accordance with the present invention includes a body (100) with a first through hole (101) defined through the body (100), a disk (11) formed on a bottom face of the body (100) and multiple first securing elements (12) continuously formed on a bottom face of the disk (11). Each first securing element (12) has a first stopping face (121). The washer (20) in accordance with the present invention includes an annular disk (21) having a size corresponding to that of the disk (11), a second through hole (22) defined through the annular disk (21) to correspond to and communicate with the first through hole (10) of the nut (10), multiple second securing elements (23) continuously formed on a top face of the annular disk (21) to correspond to the first securing elements (12) of the nut (10), a wall (24) formed on an outer periphery of the annular disk (21) and provided with cutouts (241) defined in a side face of the wall (24) and multiple abutting elements (211) formed on a bottom face of the annular disk (21). Each of the second securing elements (23) has a second stopping face (231) formed to correspond to one of the first stopping faces (121) of the nut (10).

With reference to FIG. 2 and still using FIG. 1 for reference, it is noted that each of the first securing elements (12) is an inclined surface and the first stopping face (121) has a height. Each of the second securing elements (23) is an inclined surface and the second stopping face (231) has a height the same as that of the first stopping face (121) of the first securing elements (12). The abutting elements (211) formed on the bottom face of the annular disk (21) are triangular cutouts as shown in FIG. 2.

With reference to FIG. 3, it is noted that when the nut (10) and the washer (20) are combined, the first securing elements (12) and the second securing elements (23) are securely engaged with each other and the first stopping faces (121) abutted against the second stopping faces (231). Then the wall (24) is bent to enclose the disk (11) of the nut (10) so as to conceal that the nut and the washer (20) are two separated elements. Furthermore, the height of the first stopping face (121) as well as the second stopping face (231) is larger than a pitch of the threading formed on an inner periphery of the first through hole (101).

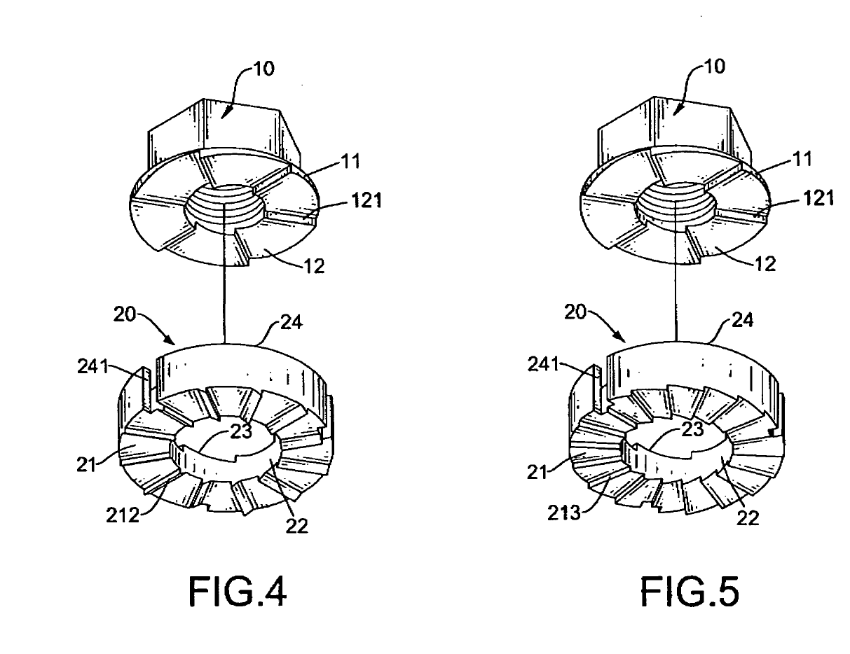

With reference to FIG. 4, it is noted that each of the abutting elements (211) of the washer (20) is now a protruded triangle. FIG. 5 shows that each of the abutting elements (211) is now a wedged protrusion. With the provision of the abutting elements (211) on the bottom face of the washer (20), the engagement between the combination of the nut (10) and the washer (20) and a workpiece is ensured.

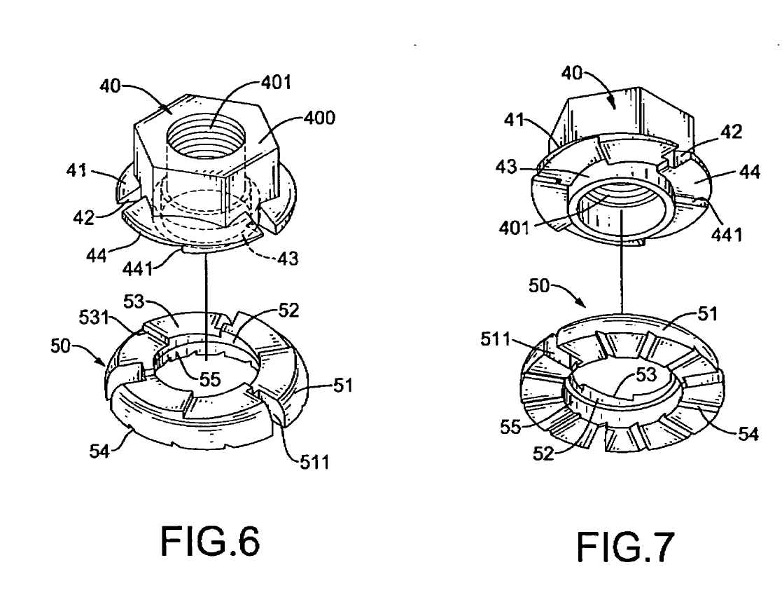

With reference to FIG. 6 and FIG. 7, a nut (40) in accordance with the present invention includes a body (400) with a first through hole (401) defined through the body (400) and provided with a threading formed on an inner face defining the first through hole (401), a disk (41) formed on a bottom face of the body (400), first cutouts (42) defined in the disk (41), multiple first securing elements (44) continuously formed on a bottom face of the disk (41) and an annular flange (43) extending from a bottom face defining the first through hole (401). Each first securing element (44) has a first stopping face (441). Each of the first securing elements (12) and of the second securing elements (23) is inclined toward a direction opposite to that of an extension of the abutting elements (211).

The washer (50) in accordance with the present invention includes an annular disk (51) with multiple second cutouts (511), a second through hole (52) defined through the annular disk (21) to have a size slightly larger than that of the annular flange (43), multiple second securing elements (53) continuously formed on a top face of the annular disk (51) to correspond to the first securing elements (44) of the nut (40) and multiple abutting elements (54) formed on a bottom face of the annular disk (51). Each second securing element (53) has a second stopping face (531). A step (55) is formed on the inner face defining the second through hole (52) to correspond to the annular flange (43) of the nut (40) a wall (24) formed on an outer periphery of the annular disk (21) and provided with cutouts (241) defined in a side face of the wall (24) and multiple abutting elements (211) formed on a bottom face of the annular disk (21). Each of the second securing elements (23) has a second stopping face (231) formed to correspond to one of the first stopping faces (121) of the nut (10). When the nut (40) and the washer (50) are combined, the annular flange (43) is extended into the second through hole (52) and the annular flange (43) is bent outward so as to enclose the step (55) of the washer (50). Because the first securing elements (44) and the second elements (53) are mutually abutted to one another via the first stopping faces (441) and the second stopping faces (531), the combination of the nut (40) and the washer (50) may be considered as an integral part. It is noted that the abutting elements (54) in this embodiment are triangular cutouts.

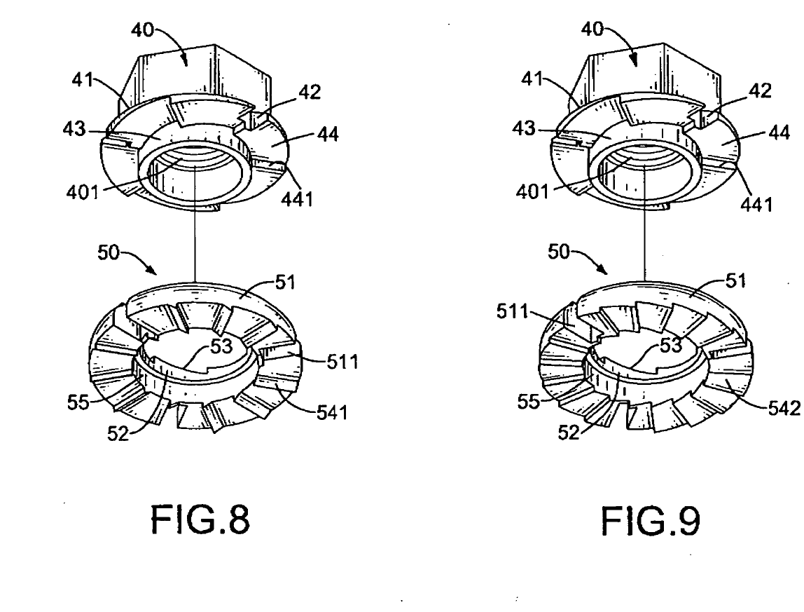

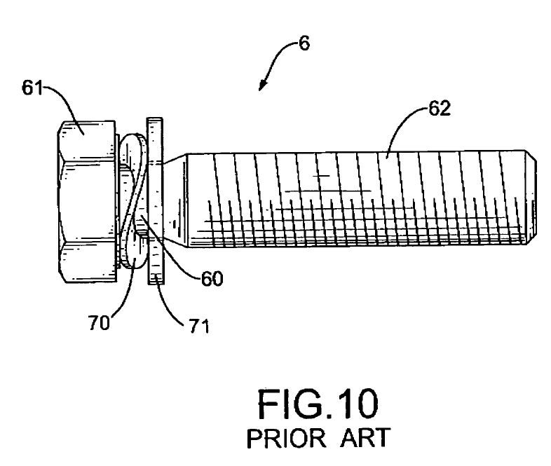

With reference to FIG. 8, the abutting elements (54) in this embodiment are triangular protrusions (541) and the abutting elements in the embodiment shown in FIG. 9 are wedged teeth (542).

From the foregoing description, it is learned that the combination of a nut and a washer of the present invention has the following advantages:
1. Due to the concealing feature concerning the connection between the nut and the washer, unauthorized personnel can not recognize that actually the combination of the nut and the washer is actually composed of two separated parts.
2. The provision of the abutting elements on the bottom face of the annular disk is able to securely engage with a workpiece surface to ensure the engagement therebetween.
3. The height of either the first stopping face or the second stopping face is larger than a pitch of the threading inside the first through hole of the nut such that without special auxiliary tool, there is no way to separate the engagement between the combination of the nut and the washer and the workpiece.
4. The engagement between the first securing elements and the second securing elements facilitates the tightening process of the combination of the nut and the washer to the workpiece when the combination of the nut and the washer is applied.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

1. A combination of a nut and a washer, in which
the nut comprises:
a body with
a first through hole defined through the body; and
a bottom face;
a thread formed on an defining surface of the first through hole; and
a disk formed on the bottom face of the body and having
a bottom face;
multiple first securing elements being inclined surfaces formed continuously on the bottom face of the disk of the nut, and each first securing element having a first stopping face; and
the washer comprises:
an annular disk having
a second through hole defined through the annular disk to communicate with the first through hole in the nut; and
a bottom face
multiple second securing elements being inclined surfaces formed continuously on a top face of the annular disk of the washer to securely engage with the first securing elements of the nut and each second securing element having a second stopping face;
multiple abutting elements formed on the bottom face of the annular disk of the washer for securing engagement with a surface of a workpiece; and
a wall is formed on an outer edge of the annular disk of the washer enclose the disk of the nut;
wherein each first stopping face and each second stopping face has a height larger than a pitch of the threading so that rotation of the nut relative to the washer to separate the nut from the washer is prevented.

2. The combination of a nut and a washer as claimed in claim 1, wherein the wall has multiple cutouts defined in a side face of the wall of the washer and each abutting element is a triangular cutout.

3. The combination of a nut and a washer as claimed in claim 1, wherein the wall has multiple cutouts defined in a side face of the wall of the washer and each abutting element is a triangular protrusion.

4. The combination of a nut and a washer as claimed in claim 1, wherein the wall has multiple cutouts defined in a side face of the wall of the washer and each abutting element is a wedged tooth.

5. A combination of a nut and a washer, in which
the nut comprises:
a body with
a first through hole defined through the body; and
a bottom face;
a thread formed on an inner surface of the first through hole;
and
a disk formed on the bottom face of the body and having
a bottom face;
multiple first securing elements being inclined surfaces formed continuously on the bottom face of the disk, and each first securing element having a first stopping face;
multiple first cutouts defined through an outer edge of the disk of the nut; and
an annular flange extending from a bottom edge of the first through hole;
the washer comprises:
an annular disk having
a second through hole defined through the annular disk to communicate with the first through hole in the nut; and
a bottom face
multiple second securing elements being inclined surfaces formed continuously on a top face of the annular disk of the washer to securely engage first securing elements of the nut, and each second securing element having a second stopping face;
multiple second cutouts through an outer edge of the annular disk of the washer;
multiple abutting elements formed on the bottom face of the annular disk of the washer for securing engagement with a surface of a workpiece; and
a step is formed on an inner surface of the second through hole such that the annular flange is able to enclose the step after being extended into the second through hole of the washer to integrally combine the nut and the washer;
wherein each first stopping face and each second stopping face has a height larger than a pitch of the threading so that rotation of the nut relative to the washer to separate the nut from the washer is prevented.

6. The combination of a nut and a washer as claimed in claim 5, wherein each abutting element is of a triangular cutout.

7. The combination of a nut and a washer as claimed in claim 5, wherein each abutting element is of a triangular protrusion.

8. The combination of a nut and a washer as claimed in claim 5, wherein each abutting element is of a wedged tooth
